(19) United States
(12) Patent Application Publication
(10) Pub. No.: US 2012/0108414 A1
(43) Pub. Date: May 3, 2012

(54) METHOD FOR STRENGTHENING CERAMICIZATION OF FLOATED CRYSTALLIZABLE GLASS

(75) Inventors: Bernd Ruedinger, Woerrstadt (DE); Friedrich Siebers, Nierstein (DE); Gerhard Lautenschlaeger, Jena (DE); Matthias Baesel, Eisfeld (DE)

(73) Assignee: SCHOTT AG, Mainz (DE)

(21) Appl. No.: 13/288,064

(22) Filed: Nov. 3, 2011

(30) Foreign Application Priority Data
Nov. 3, 2010 (DE) 102010043326.8-45

(51) Int. Cl. C03C 14/00; C03C 10/00

(52) U.S. Cl. 501/32; 65/33.9

(57) ABSTRACT

A method of ceramicizing a floated glass is provided where the glass ceramic material obtained thereby has high stability because of the special quality of the atmosphere in the ceramicizing process. The glass ceramics thus obtained have special surface properties that avoid crack formation. Thereby very high bending tensile strengths are achieved. These glass ceramics can be used as fire protection glass, hot plate of a cooker having a coating on the lower side, safety glass, panes of wood-burning fireplace inserts, in colored form as hot plate of a cooker, base plate, thermally resistant panel lining in furnaces and microwave facilities.

### CROSS REFERENCE TO RELATED APPLICATIONS

This application claims benefit under 35 U.S.C. §119(a) of German Patent Application No. 10 2010 043 326.8-45, filed Nov. 3, 2010, the entire contents of which are incorporated herein by reference.

### BACKGROUND OF THE INVENTION

1. Field of the Invention

This invention relates to a method of ceramicizing a floated glass, wherein the glass ceramic material obtained thereby has high stability because of the special quality of the atmosphere in the ceramicizing process.

2. Description of Related Art

It is known that glasses of the system Li₂O—Al₂O₃—SiO₂ can be converted into glass ceramics (LAS glass ceramics) having mixed high quartz crystals and/or mixed keatite crystals as the main crystal phases. The production of these glass ceramics is conducted in different steps. After the steps of melting and hot molding normally the material is cooled below the transformation temperature. Subsequently, the starting glass is transformed into a glass-ceramic article by controlled crystallization.

DE 100 17 701 C2 discloses a floated flat glass which can be tempered or can be converted into a glass ceramic having mixed high quartz crystals or mixed keatite crystals. To avoid disturbing surface defects during the floating step the glass contains less than 300 parts-per-billion (ppb) of Pt, less than 30 ppb of Rh, less than 1.5% by weight of ZnO and less than 1% by weight of SnO₂ and in the melting step it is refined without the use of the common refining agents arsenic and/or antimony oxide.

In U.S. Pat. No. 6,358,869 B1 a “lithium depleted” (Li depleted) region on the glass ceramic surface is described. The tendency to the formation of cracks which is mentioned there is caused by decomposition of the Li high quartz phase through a H₂SO₄ containing atmosphere, as used for example for panes of wood-burning fireplace inserts. The Li depleted region reduces this kind of tendency to the formation of cracks.

U.S. Pat. No. 6,593,258 B1 describes the effects of the fraction of β-OH in the glass ceramic on the formation of micro cracks in the surface. Through the fraction of β-OH in the glass ceramic an exchange reaction between Li ions in the Li mixed high quartz crystal and hydrogen ions is suppressed. This is the reason why the formation of micro cracks is prevented.

DE 33 45 316 A1 discloses a method for the production of glass ceramics for window glass in wood- and coal-burning stoves in which the molten glass is converted into a glass ceramic by heat treatment and this or the glass is subjected to an ion exchange treatment, by which the content of lithium ions is reduced up to a depth of at least 10 μm. The ion exchange is conducted for example in DE 33 45 316 A1 through the treatment with a strong mineral acid such as H₂SO₄, HCl or HNO₃ at temperatures of about 35 to 320° C. for the exchange of Li⁺ ions with H⁺ ions up to a depth of at least 10 μm and preferably at least 25 μm for a sufficient period of time. Subsequently, the glass is crystallized in situ into a glass ceramic through a suitable heat treatment (about 200° C. per hour, which is relatively slow) and is subsequently further heated up to the crystallization range so that H₂O is completely and nondestructively removed from the crystal structure.

One of the main reasons for the formation of cracks in LAS glass ceramics is the ion exchange of Li⁺ with H⁺ in a surface layer with different thickness which is dependent on the intensity and duration of the attack caused through different substances, in particular through SO₂+H₂O→H₂SO₄. Since the Li⁺ ion is incorporated in the glass ceramic in a high percentage rate, this exchange results in a change of the crystal properties with partial amorphization and partial changes of the d value, i.e. change of the coefficient of thermal expansion in the respective region. Associated therewith, stress is caused and thus cracks. This according to the attack results in cracks with a depth of up to 100 μm, leading to in a substantial lowered surface strength of the respective glass ceramic.

After a standard step of ceramicization under normal atmosphere, the floated glass ceramic often has a strongly lowered impact and bending tensile strength. The reason for that are surface cracks which predominantly appear only on one side namely on the upper side of the float glass which in the case of tensile load may result in an early fracture of the glass ceramic.

When such surface cracks are present, the characteristic limit values of ≧45 MPa (according to DIN EN 1748-2-1) which are required for structural engineering are not achieved. Also the impact strengths of at least 0.5 Nm which are required e.g. for the use as hot plates of cookers according to the spring-hammer test (according to DIN EN 60335) are not achieved. Due to the extremely low strength the glass ceramic cannot be used for products for example in the field of fire protection, as safety glass or as hot plate of a cooker. FIG. 1 shows the formation of cracks on the surface of the upper side of a float glass of a glass ceramic which has been ceramicized under “normal” atmosphere.

The cracks can be removed from the surface by polishing. But this method is very time consuming and costly due to the depths of the present cracks of partially more than 100 μm. In FIG. 2 for example a crack having a depth of ca. 90 μm in the fracture edge of a floating upper side of a ceramicized glass ceramic after a standard ceramicization in a roller passage kiln is shown. The depth to be polished can be significantly reduced when the floated green glass is polished prior to the step of ceramicization. Therefore, polishing depths of ca. 15 μm to 20 μm are sufficient according to studies on floated glass ceramics. But also in this case the additional production step makes the production of the product much more expensive. Since until today no glass ceramic has been produced through a floating process in a larger commercial scale, there is no information given in literature which addresses the problem of a crack-free ceramicization in this system.

The reason for the formation of cracks is the formation of a very thick Li depleted surface layer of >1 μm during the ceramicization process. The non-crystallized surface layer has a considerably higher coefficient of thermal expansion (normally >4×10⁻⁶ 1/K) compared with the predominantly crystallized interior zone (usually <0.5×10⁻⁶ 1/K).

### BRIEF SUMMARY OF THE INVENTION

The resultant stress results in cracks in the surfaces during the cooling step. The atmosphere of the floating bath changes the surface of the glass in such a way that a glassy surface layer having a thickness of more than 4 μm in parts is formed during the ceramicization process of a ceramicization under normal ambient atmosphere with typically <4% by volume of water vapor which inevitably results in a strong formation of cracks in the surface. The surface cracks having a depth of up to 100 μm dramatically reduce the impact strength and bending tensile strength.

The influence of a forming gas atmosphere in the floating bath onto the later micro-structure of the glass ceramic has not yet been described in literature.

It is the object of the present invention to provide a method according to which improved glass ceramics can be produced. According to the improved method floated crystallizable glasses should be ceramicized in such a way that the obtained glass ceramics have crack-free surfaces and improved bending tensile strengths and impact strengths. Preferably, these properties meet special specifications such as a characteristic bending tensile strength of ≧45 MPa according to DIN EN 1748-2-1 and an impact strength of at least 0.5 Nm according to DIN EN 60335.

This object is solved by a method for the ceramicization of a floated glass comprising a ceramicization step characterized in that this step is conducted in an atmosphere which comprises a hydrogen compound, wherein the hydrogen compound is selected from the group consisting of water vapor and molecular hydrogen and is present in the atmosphere in an amount of higher than or equal to 3% by volume in the case of water vapor, or of higher than or equal to 2% by volume in the case of hydrogen, wherein the obtained glass ceramic has a bending tensile strength of at least 30 MPa. Preferably, the surfaces of the upper and the lower side of the floated glass are exposed to the respective atmosphere comprising a hydrogen compound according to the present invention.

According to the present invention water vapor and hydrogen are hydrogen compounds.

The fractions of hydrogen compounds in the atmosphere during the step of ceramicization of a floated glass are specifically adjusted and preferably are maintained constant during the ceramicization. In particular it is important that during the ceramicization step prior to reaching the transformation temperature and till the end of the first crystallization step the hydrogen content does not fall below a value of 2% by volume, in particular 3% by volume.

The method according to the present invention for the ceramicization of a floated glass preferably comprises a step of ceramicization in an atmosphere which contains water vapor in fractions of at least 4% by volume. According to the present invention it is further preferable that the atmosphere comprises at least 5% by volume of water vapor. Further preferably, the water vapor atmosphere comprises at least 6% by volume of water vapor, further preferably at least 7% by volume of water vapor and according to a further embodiment at least 8% by volume of water vapor.

In a further embodiment the method according to the present invention for the ceramicization of a floated glass comprises a ceramicization step in an atmosphere comprising hydrogen in fractions of at least 5% by volume to 20% by volume. Preferably, the atmosphere comprises >5% to 20% by volume, more preferably ≧5.5% to 20% by volume of hydrogen. In one embodiment the atmosphere comprises 10 to 20% by volume of hydrogen. The ceramicization step can be conducted in a forming gas atmosphere. The forming gas comprises nitrogen and hydrogen. With mixtures of H₂ and N₂ as the atmosphere of the ceramicization process a crack-free surface of the resulting glass ceramic can be obtained. But contents of hydrogen of >20% by volume are not feasible, since in the case of high concentrations of hydrogen the flammability is increased and thus stronger safety measures have to be taken.

It is preferable that the obtained glass ceramic has a bending tensile strength of at least 30 MPa and preferably of at least 45 MPa. The method according to the present invention can provide glass ceramics which have an impact strength of at least 0.5 Nm according to DIN EN 60335.

Surprisingly it was found that the formation of cracks and thus the reduction of strength can be prevented by a ceramicization under wet atmosphere or alternatively under mixtures of H₂ and N₂. The wet atmosphere is adapted according to the base composition of the glass ceramic and the adjusted conditions in the floating bath. At typical floating conditions the formation of cracks is prevented, when the subsequent ceramicization is conducted in an atmosphere of preferably at least 6% by volume of absolute humidity. In this case the bending tensile strengths are considerably higher than 30 MPa. The prevention of the formation of cracks can also be achieved by the subsequent ceramicization in forming gas atmosphere with about 10% by volume of H₂ and about 90% by volume of N₂. The formulation “about X % by volume” preferably means the same as “X±2% by volume”. Very good results are obtained in a forming gas atmosphere with 10% by volume of H₂ and 90% by volume of N₂.

The required humidities of the atmosphere can be obtained by humidification of the supplied air during the ceramicization step as well as through a ceramicization in gas humidified kilns.

The thickness of the Li depleted layer on the upper and/or lower side of the glass ceramic is preferably lower than 2000 nm, further preferably lower than 1000 nm. In the sense of the present invention the term Li depleted layer means a nearly completely glassy (thus amorphous) surface region adjacent to the predominantly crystalline interior zone of the glass ceramic. These zones can also be partly connected through a transition zone. In other words, preferably the glass ceramic according to the present invention comprises at least one amorphous layer on the upper side and preferably also on the lower side. The upper side is the floating upper side, thus the surface of the glass ceramic which is opposite to the floating bath.

Compliant with the method according to the present invention for example glasses having a composition which comprises the following main components, based on % by weight, on oxide basis can be ceramicized: 3 to 5% by weight of Li₂O, 18 to 25% by weight of Al₂O₃ and 55 to 70% by weight of SiO₂.

In one embodiment the composition of a glass which can be ceramicized according to the method of the present invention is as follows (% by weight on oxide basis):

| | |
|---|---|
| SiO₂ | 55 to 69% by weight, |
| Al₂O₃ | 19 to 25% by weight, |
| Li₂O | 3.2 to 5% by weight, |
| Na₂O | 0 to 1.5% by weight, |
| K₂O | 0 to 1.5% by weight, |
| MgO | 0 to 2.2% by weight, |
| CaO | 0 to 2.0% by weight, |
| SrO | 0 to 2.0% by weight, |
| BaO | 0 to 2.5% by weight, |
| ZnO | 0 to <1.5% by weight, |
| TiO₂ | 0 to 3% by weight, |
| ZrO₂ | 1 to 2.5% by weight, |
| SnO₂ | 0.1 to <1% by weight, |
| Σ TiO₂ + ZrO₂ + SnO₂ | 2.5 to 5% by weight, |
| P₂O₅ | 0 to 3% by weight, |
| F | 0 to 1% by weight, and |
| B₂O₃ | 0 to 2% by weight, |

as well as optional additives of coloring oxides such as Fe₂O₃, CoO, NiO, V₂O₅, Nd₂O₃, CeO₂, Cr₂O₃, MnO₂ in amounts of up to 1% by weight.

Glass ceramics prepared in line with the method of the present invention can be used according to the present invention as fire protection glass, hot plate of a cooker having a coating on the lower side, safety glass, panes of wood-burning fireplace inserts, in colored form as hot plate of a cooker, base plate, thermally resistant panel lining in furnaces and microwave facilities. In preferable embodiments the glass ceramics are transparent.

When in this application no other definition is given, then the residual fraction of the respective atmosphere, thus, the fraction besides the hydrogen compound is preferably air.

Also a ceramicized float glass which has been prepared according to a method described herein is according to the present invention. A feature of the float glass thus obtained is a bending tensile strength of at least 30 MPa, preferably even at least 45 MPa. In addition, it is different from other ceramicized float glasses with respect to the other above-described properties, which are preferably present on the surfaces of the upper and the lower side of the floated glass.

The glasses according to the present invention are preferably melted in a melting tank in common oxygen containing atmosphere with raw materials which are common in glass industry and preferably transferred into the floating part with reducing atmosphere over a fluting and cast onto the floating bath.

Normally, the temperatures of the glass are about 1200° C. at the end of the restrictor tiles. At the end of the floating bath the glass is removed preferably nearly above the transformation temperature and is preferably stress-relieved in a cooling device.

According to the present invention, ceramicization is carried out in a kiln as a separate step after the glass has been removed from the floating bath.

Consequently, in a further step the obtained glass is converted into a glass ceramic by tempering in a kiln. In a first tempering step the starting glass (glass article) is subjected to a heating phase, in particular at temperatures of up to 735° C. The glass article is preferably held in the nucleation phase for about 45 minutes. In a further heating phase the article is heated with a heating rate of preferably about 1° C./min to a temperature of preferably up to 830° C. Here most of the crystallization happens. A preferably subsequent heating phase of 10 minutes up to 870° C. is mainly conducted for the prevention and the reduction of residual stress in the formed glass ceramic. Thereafter, the article is again cooled to room temperature.

### BRIEF DESCRIPTION OF THE DRAWINGS

FIG. 1: Detail of a floating upper side (top view) of a ceramicized glass ceramic after ceramicization under “normal” atmosphere.

FIG. 2: Image of scanning electron microscope of a crack in the fracture edge of a ceramicized floating upper side of a glass ceramic after a standard ceramicization.

### DETAILED DESCRIPTION OF THE INVENTION

### EXAMPLE 1

This example was conducted with a glass melt of the composition (in % by weight on oxide basis): 66.1 SiO₂, 22.4 Al₂O₃, 4.1 Li₂O, 0.6 Na₂O, 0.2 K₂O, 1.0 MgO, 1.3 P₂O₃, 1.5 TiO₂, 2.0 ZrO₂, 0.4 SnO₂, 0.3 ZrO. The glass was melted in a melting tank in common oxygen containing atmosphere with raw materials which are common in glass industry and transferred into the floating part with reducing atmosphere over a fluting and cast onto the floating bath. The temperatures of the glass were about 1200° C. at the end of the restrictor tiles.

At the end of the floating bath the glass was removed nearly above the transformation temperature and stress-relieved in a cooling device.

In a second step the thus obtained glass was converted into a glass ceramic by tempering in a kiln. In a first tempering step the starting glass was subjected to a heating phase, in this example of up to 735° C. The article was held in the nucleation phase for 45 minutes. In a further heating phase the article here described was heated with a heating rate of 1° C./min to a temperature of 830° C. Here most of the crystallization happens.

A subsequent heating phase of 10 minutes of up to 870° C. was mainly conducted for the prevention and the reduction of residual stress in the formed glass ceramic. Thereafter, the article was again cooled to room temperature.

The ceramicization conducted here was conducted without additional introduction of atmosphere humidity so that during the whole ceramicization process the level of absolute humidity in the atmosphere was not higher than 3% by volume. The obtained glass ceramic shows a strong formation of cracks on the surfaces and low bending tensile strengths of between 26 and 37 MPa.

### EXAMPLE 2

Example 1 was repeated with the difference that during the ceramicization step prior to reaching the transformation temperature, here in this example starting from 600° C., and till the end of the first crystallization step, here in this example 850° C., an absolute humidity of at least 6% by volume prevailed in the furnace atmosphere. The glass ceramic thus obtained did not show any surface cracks. The bending tensile strengths measured were between 51 and 68 MPa.

### EXAMPLE 3

Example 1 was repeated with the difference, that the ceramicization step was conducted under a forming gas atmosphere having a fraction of hydrogen of 10%. The obtained glass ceramic did also not show any surface cracks.

The following tables show that the fraction by volume of water in the ceramicization atmosphere has a strong influence on the bending tensile strength of the respective ceramicized float glass (table 1) and that the same also applies to the fraction of volume of hydrogen (table 2).

TABLE 1
Depth of Li depletion, tendency to the formation of cracks and bending tensile
strength at different atmosphere humidities during the ceramicization step.

| | Upper side of float glass | | | Lower side of float glass | | |
|---|---|---|---|---|---|---|
| | | | Bending | | | Bending |
| Absolute humidity | Li depletion | Formation | tensile | Li depletion | Formation | tensile |
| in [% by volume] | in μm | of cracks | strength¹ | in μm | of cracks | strength¹ |
| 0.2% | 2.46 (± 0.12) | strong | 27 | 1.80 (± 0.02) | strong | 35 |
| 3% | 2.04 (± 0.10) | strong | 26 | 1.36 (± 0.07) | present | 37 |
| 6% | 0.78 (± 0.06) | no | 51 | 0.75 (± 0.06) | no | 68 |
| 8% | 0.50 (± 0.05) | no | 56 | 0.45 (± 0.05) | no | 72 |

¹according to DIN EN 1748-2-1

TABLE 2
Depth of Li depletion and tendency to the formation of cracks
at different atmospheres during the ceramicization step.

| | Upper side of float glass | | Lower side of float glass | |
|---|---|---|---|---|
| | Depth of Li | | Depth of Li | |
| Ceramicization | depletion | Formation | depletion | Formation |
| atmosphere | [μm] | of cracks | [μm] | of cracks |
| 100% N₂ | 1.7 | strong | 1.2 | low |
| Air | 1.6 | strong | 1.0 | no |
| 95% N₂ + 5% H₂ | 1.0 | no | 0.6 | no |
| 90% N₂ +10% H₂ | 0.6 | no | 0.4 | no |
| 80% N₂ + 20% H₂ | 0.7 | no | 0.4 | no |

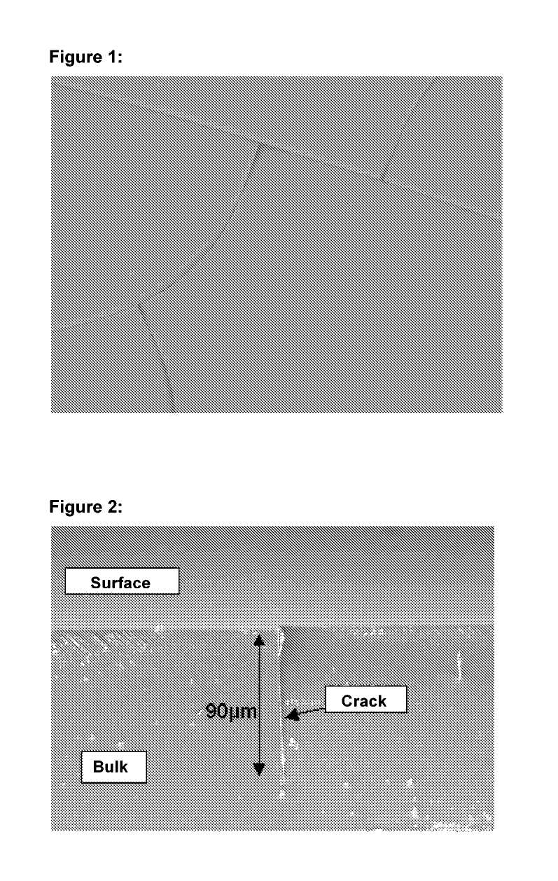

FIG. 1 details a floating upper side (top view) of a ceramicized glass ceramic after ceramicization under “normal” atmosphere. The distinctive formation of cracks on the surface can be clearly seen.

FIG. 2 is an image of scanning electron microscope of a crack in the fracture edge of a ceramicized floating upper side of a glass ceramic after a standard ceramicization.

What is claimed is:

1. A method for the ceramicization of a floated glass, comprising:
a ceramicizing the floated glass to provide a glass ceramic in an atmosphere comprising a hydrogen compound, wherein the hydrogen compound is selected from the group consisting of water vapor and molecular hydrogen, wherein the hydrogen compound is present in an amount of higher than or equal to 3% by volume when the hydrogen compound comprises water vapor or is present in an amount higher than or equal to 2% by volume when the hydrogen compound comprises hydrogen, wherein the glass ceramic has a bending tensile strength of at least 30 MPa.

2. The method according to claim 1, wherein the hydrogen compound comprises water vapour present in an amount of at least 4% by volume.

3. The method according to claim 1, wherein the hydrogen compound comprises water vapour present in an amount of at least 5% by volume.

4. The method according to claim 1, wherein the hydrogen compound comprises hydrogen present in an amount of between 5% by volume and 20% by volume.

5. The method according to claim 1, wherein the bending tensile strength of the glass ceramic is at least 45 MPa.

6. The method according to claim 1, wherein the glass ceramic is an LAS glass ceramic.

7. The method according to claim 1, wherein the floated glass comprises, on oxide basis in % by weight:
Li₂O: 3 to 5% by weight;
Al₂O₃: 18 to 25% by weight; and
SiO₂: 55 to 70% by weight.

8. The method according to claim 1, wherein the floated glass comprises a composition, which on oxide basis in % by weight, consists essentially of:

| | |
|---|---|
| SiO₂ | 55-69; |
| Al₂O₃ | 19-25; |
| Li₂O | 3.2-5; |
| Na₂O | 0-1.5; |
| K₂O | 0-1.5; |
| MgO | 0-2.2; |
| CaO | 0-2.0; |
| SrO | 0-2.0; |
| BaO | 0-2.5; |
| ZnO | 0-<1.5; |
| TiO₂ | 0-3; |
| ZrO₂ | 1-2.5; |
| SnO₂ | 0.1-<1; |
| ΣTiO₂ + ZrO₂+ SnO₂ | 2.5-5; |
| P₂O₅ | 0-3; |
| F | 0-1; and |
| B₂O₃ | 0-2, |

as well as one or more coloring oxides.

9. The method according to claim 8, wherein the one or more coloring oxides are selected from the group consisting of Fe₂O₃, CoO, NiO, V₂O₅, Nd₂O₃, CeO₂, Cr₂O₃, and MnO₂ in amounts of up to 1% by weight.

10. A ceramicized float glass prepared according to a method according to claim 1.

11. A method of utilizing the ceramicized float glass according to claim 10 as a device selected from the group consisting of a fire protection glass, a hot plate of a cooker, a safety glass, a pane of a wood-burning fireplace insert, a colored hot plate of a cooker, a base plate, and a thermally resistant panel lining a furnaces or microwave facility.

12. A method for the ceramicization of a floated glass, comprising:
ceramacizing the float glass, in an atmosphere comprising a hydrogen compound, to provide a glass ceramic, wherein, during the step of ceramacizing and prior to reaching a transformation temperature of the float glass, the method further comprises maintaining a content of the hydrogen compound in the atmosphere at a minimum value of at least 2% by volume.

13. The method according to claim 12, further comprising maintaining the minimum value during the step of ceramacizing until an end of a first crystallization step.

14. The method according to claim 12, wherein the hydrogen compound comprises water vapor and the minimum value comprises 3% by volume.

15. The method according to claim 12, wherein the hydrogen compound comprises hydrogen.

16. The method according to claim 12, wherein the step of ceramacizing comprises exposing an upper side and a lower side of the floated glass to the atmosphere.

17. The method according to claim 12, wherein the atmosphere comprises a mixture of H₂ and N₂.

18. The method according to claim 17, wherein the mixture comprises about 10% by volume of H₂ and about 90% by volume of N₂.

19. The method according to claim 12, wherein the step of ceramacizing further comprises:
heating and holding the float glass in a nucleation phase at a first temperature;
increasing from the first temperature to a second temperature in a further heating phase;
increasing from the second temperature to a third temperature in a subsequent heating phase; and
cooling the glass ceramic to room temperature.
